(19) United States
(12) Patent Application Publication
(10) Pub. No.: US 2003/0058848 A1
(43) Pub. Date: Mar. 27, 2003

(54) Scheduling clos networks

(75) Inventor: William J. Dally, Stanford, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Velio Communications, Inc., Milpitas, CA (US)

(21) Appl. No.: 10/141,499

(22) Filed: May 7, 2002

Related U.S. Application Data
(63) Continuation-in-part of application No. 09/992,528, filed on Nov. 14, 2001, now abandoned.
(63) Continuation-in-part of application No. 09/761,538, filed on Jan. 16, 2001.
(60) Provisional application No. 60/248,273, filed on Nov. 14, 2000.
(60) Provisional application No. 60/237,086, filed on Sep. 28, 2000.
(60) Provisional application No. 60/195,998, filed on Apr. 11, 2000.

(51) Int. Cl. H04L 12/50; H04Q 11/00

(52) U.S. Cl. 370/360

(57) ABSTRACT

Improvements to scheduling of calls on a three stage network are provided. A multicast call is divided into plural portions which are scheduled separately. Protection channels are scheduled with primary channels by augmenting a call with an input switch containing the protection channel. Calls are scheduled on a set of free middle stage switches or time slots and are then added to a primary set. On occasion, the primary set is recompacted. Different sets of calls may be scheduled on different sets of middle stage switches or time slots, and each set may rely on a different scheduling algorithm.

### RELATED APPLICATION

This application is a continuation-in-part of U.S. Application Ser. No. 09/992,528, filed Nov. 14, 2001, which claims the benefit of U.S. Provisional Application Ser. No. 60/248,273, filed on Nov. 14, 2000, and U.S. Application Ser. No. 09/761,538 filed Jan. 16, 2001, which claims the benefit of U.S. Provisional Application Ser. No. 60/237,086 filed Sep. 28, 2000 and U.S. Provisional Application Ser. No. 60/195,998 filed Apr. 11, 2000. The entire teachings of the above applications are incorporated herein by reference.

### BACKGROUND OF THE INVENTION

Telecommunications channels often carry traffic that is multiplexed from several sources. For example, a 2.488Gb/s SONET STS-48 channel carries 48 51.84Mb/s SONET STS-1 channels that are time multiplexed on a byte-by-byte basis. That is, the channel carries bytes 1.1, 2.1, 3.1, . . . , 48.1, 1.2, 2.2, 3.2, . . . , 48.2, 1.3, 2.3, 2.3, . . . where n.m denotes byte m of subchannel n. Details of the SONET format can be found in Ming-Chwan Chow, Understanding SONET/SDH: Standards & Applications, And an Pub, ISBN 0965044823, 1995 and in ANSI Standard T1.105-1995.

An STS-1 SONET frame is a repeating structure of 810 bytes arranged into 9 rows of 90 columns. The frame structure is transmitted in row-major order. That is, all 90-bytes of row 0 are transmitted, then all 90 bytes of row 1, and so on. At higher multiplexing rates, each byte of the STS-1 frame is replaced by a number of bytes, one from each of several multiplexed sources. For example, at STS-48, 48 bytes, one from each of 48 STS-1 subframes, are transmitted during each column interval. In this case, the order of transmission is to send all 48 subframe bytes for one column before moving on to the next column and to send all of the columns of a row before moving on to the next row.

A digital cross connect is a network element that accepts a number of multiplexed data channels, for example 72 STS-48 channels, and generates a number of multiplexed output channels where each output channel carries an arbitrary set of the subchannels from across all of the input ports. For example, one of the STS-48 output channels may contain STS-1 channels from different input channels in a different order than they were originally input.

An example of digital cross connect operation is shown in FIG. 1. The figure shows a cross connect 30 with two input ports and two output ports. Each of these ports contains four time slots. Input port 1 (the top input port) carries subchannels A, B, C, and D in its four slots and input port 2 (the bottom port) carries subchannels E, F, G, and H in its four time slots. Each time slot of each output port can select any time slot of any input port. For example, output port 1 (top) carries subchannels H, D, F, and A from 2.4, 1.4, 2.2, 1.1 where x.y denotes input port x, timeslot y. Input timeslots must be switched in both space and time. The first time slot of output port 1, for example must be switched in time from slot 4 to slot 1 and in space from port 2 to port 1. Also, some time slots may be duplicated (multicast) and others dropped. Subchannel A, for example, appears in output time slots 1.4 and 2.2 and subchannel G is dropped, appearing on no output time slot.

A digital cross connect can be implemented in a straightforward manner by demultiplexing each input port, switching all of the time slots of all of the input ports with a space switch, and then multiplexing each output port. This approach is illustrated in FIG. 2. The four time slots of input port 1 are demultiplexed (Demux) in demultiplexers 32 so that each is carried on a separate line. All of these demultiplexed lines are then switched by a space switch 34 to the appropriate output time slots. Finally, a set of multiplexers (Mux) 36 multiplexes the time slots of each output channel onto each output port. This approach is used, for example, in the systems described in U.S. Pat. Nos. 3,735,049 and 4,967,405.

The space-switch architecture for a digital cross connect as shown in FIG. 2 has the advantage that it is conceptually simple and strictly non-blocking for arbitrary unicast and multicast traffic. However, it results in space switches that are too large to be economically used for large cross connects. For example, a digital cross connect with P=72 ports and T=48 time slots requires a PT×PT (3456 ×3456) space switch with P²T²=11,943,936 cross points. Further, this large switch will be operated at a very slow rate. It will only need to switch a new batch of input time slots after T bytes have been received. Thus, it operates at 1/T the byte rate.

A more economical digital cross connect can be realized using a time-space-time (T-S-T) switch architecture as illustrated in FIG. 3. Here each input port is input to a time-slot interchanger (TSI) 38. A TSI switches a multiplexed input stream in time by interchanging the positions of the time slots. To switch time-slot i to time-slot j, for example, slot i is delayed by T+j−i byte times. The multiplexed streams out of the input TSIs are then switched by a P×P space switch 40 that is reconfigured on each time slot. The outputs of this space switch are switched in time again by a set of output TSIs 42. This T-S-T architecture is employed, for example, by the systems described in U.S. Pat. Nos. 3,736,381 and 3,927,267.

An example of the operation of a T-S-T digital cross connect on the configuration of FIG. 3 is shown in FIG. 4A. Here the TSI for input port 1 does not change the positions of its input time slots. The input TSI for port 2, however, reorders its time slots from E, F, G, H, to —, F, H , E. The G here is dropped as it is not used by any output ports. The space switch takes the outputs of the two input TSIs and switches them, without changing time slots, to create the streams A, F, H, D and A, B, C, E. Note that this involves a multicast of timeslot A to both outputs. Finally, the output TSIs reorder these streams to give the output streams H, D, F, A and E, A, B, C.

A three-stage T-S-T digital cross connect is logically equivalent to a 3-stage Clos network with P T×T input stages, T P×P middle stages, and P T×T output stages. Clos networks are normally described in terms of the number of input and output switches, r, and number of ports per input and output switch, n, and the number of middle stage switches, m. Here P is equivalent to r and T is equivalent to both m and n. A Clos network, whether it is realized as a T-S-T switch or as an S-S-S switch, may have speedup in which case m>n. For a T-S-T switch this means that there are more middle stage time slots than there are input and output time slots.

FIG. 4B shows the configuration of FIG. 4A on an equivalent 3-stage S-S-S Clos network. The switch consists of three stages all of which are crosspoint space switches that collectively form the S-S-S Clos network. The first stage consists of two 4×4 input switches. Each input switch connects to each of the four 2×2 middle-stage switches. Each of these middle-stage switches in turn connects to each of the 4×4 output switches. Each line in the figure is labeled with the data it is carrying. The input and output time slots of the T-S-T switch of FIG. 4A correspond to the ports on the input and output switches of FIG. 4B. The middle-stage time slots of FIG. 4A correspond to the middle-stage switches of FIG. 4B.

To route a configuration of input time slots to output time slots on such a T-S-T switch, a middle-stage time slot must be assigned to each connection. This routing in a Clos network is described in detail in Clos, Charles, “A Study of Non-Blocking Switching Networks”, Bell System Technical Journal, Mar. 1953, pp. 406-424, and V. E. Benes, “On Rearrangeable Three-Stage Connecting Networks”, The Bell System Technical Journal, vol. XLI, No. 5, Sep. 1962, pp. 1481-1492. These references show that a 3-stage Clos network, and hence a T-S-T digital cross connect, is rearrangeably non-blocking for unicast traffic but cannot, in general route multicast traffic.

A network is rearrangeably non-blocking, or rearrangeable, for unicast traffic, if for every input to output permutation, there exists an assignment of middle stage time slots that will route that permutation. A network is strictly non-blocking if an existing configuration can be augmented to handle any new connection between an idle input time slot and an idle output time slot without changing the time slots assigned to any existing connection.

From its input and output terminals, a rearrangeable network is indistinguishable from a strictly non-blocking network if its configuration changes are (1) aligned to the start of a frame and (2) frame synchronized so that all TSIs and space switches switch their configurations at the start of the same frame. Such frame synchronized switching is referred to as hitless because it does not hit or corrupt the contents of any frames. There is no impact of rearranging existing connections as long as such rearrangement is hitless. Thus, with hitless switching, there is little advantage to strictly non-blocking switches. Hitless switching is provided in Lucent 800 and 900 series digital cross connects (see http://connectivitvl.avava.com/exchangemax/).

To set up a set of calls on a TST digital cross connect requires that each call be assigned to a non-conflicting time slot. Each call A must be scheduled a time slot that has no other calls on it that originate from the same input port as call A or terminate on the same output port as call A. As described above, this problem of assigning time slots to calls is identical to the problem of routing calls in a 3-stage Clos network. In the past this scheduling problem was solved using a looping algorithm that is described in Benes The Mathematical Theory of Connecting Networks, 1964.

There have been many minor variations to this basic scheduling algorithm. U.S. Pat. No. 3,576,398 describes a scheduling algorithm that prioritizes the scheduling of certain calls over others. U.S. Pat. No. 4,004,103 describes a scheduling algorithm that randomizes the allocation of paths. U.S. Pat. No. 5,345,441 allocates different sized contiguous blocks of calls. U.S. Pat. No. 5,430,716 describes a method for scheduling multicast and broadcast calls. U.S. Pat. No. 5,987,027 describes a rearrangement algorithm for scheduling multicast calls. U.S. Pat. No. 6,034,947 describes the use of scheduling for protection switching. U.S. Pat. No. 5,408,231 describes another alternative implementation.

### SUMMARY OF THE INVENTION

Disclosed herein are improved methods of a scheduling calls which have a particular application to scheduling of multicast calls on networks of at least three stages.

In accordance with one method, a multicast call is scheduled by first dividing the call into a plurality of a call portions. The call portions are then scheduled with other calls. By thus dividing the multicast call, a conflict with only a portion of a multicast call which would have precluded the multicast call from being scheduled with another call can be avoided. Each portion of the multicast call can be combined with different non-conflicting calls.

The network may be a time-space-time network or space-space-space network.

A call with a fanout of F may, for example, be divided into two F/2 calls. Alternatively, a fanout of F call may be divided into about the square-root of F calls. A fanout of a 2 call may be divided into 2 unicast calls.

Unicast calls may be scheduled using a looping algorithm while multicast calls are scheduled using a greedy algorithm.

Where a system uses protection channels to replace poorly performing primary channels, a protection channel may be scheduled as the primary channel is scheduled. To that end, a call is augmented by adding an input switch containing the protection channel to the call. The augmented call is then scheduled. Calls may be scheduled from a configuration matrix with two non-zero entries on the input side.

In accordance with another method, calls are scheduled on a set of free middle stage switches or time slots and then added to a first set of calls. Specifically, a first set of calls is maintained on a first set of middle stage switches or time slots. New calls are scheduled on a second set of middle stage switches or time slots drawn from a set of free middle stage switches or time slots. The scheduled new calls are then added to the first set of calls and the second set of middle stage switches or time slots are added to the first set of middle stage switches or time slots. On occasion, the first set of calls are recompacted on the first set of middle stage switches or time slots.

New calls may be assigned one per middle stage switch. Middle stage switches or time slots freed by recompacting may be returned to the set of free middle stage switches or time slots.

In accordance with another method, a first set of calls are assigned to a first set of middle stages, switches or time slots and a second set of calls are assigned to a second set of middle stage switches or time slots. The two sets of calls are scheduled separately.

The first set of calls may be scheduled with a first algorithm, and the second set of calls may be scheduled with a second algorithm. For example, the first set of calls may be unicast calls which are scheduled with a looping algorithm, while the second set of calls are multicast calls scheduled with a greedy algorithm.

### BRIEF DESCRIPTION OF THE DRAWINGS

FIG. 1 is an illustration of a prior art time-space-time digital cross connect.

FIG. 2 is an implementation of a digital cross connect of FIG. 1.

FIG. 3 is an alternative implementation of the interconnect FIG. 1.

FIG. 4A illustrates an example operation of the digital cross connect of FIG. 3.

FIG. 4B illustrates operation of a space-space-space Clos network equivalent to the network of FIG. 4A.

FIG. 5 is a configuration matrix for each of FIGS. 4A and 4B.

FIG. 6 is an assignment vector for each of FIGS. 4A and 4B.

FIG. 7 is an assignment matrix for each of FIGS. 4A and 4B.

FIG. 8 is an inverse assignment matrix for each of FIGS. 4A and 4B.

FIG. 9 illustrates and example time-space-time network utilizing protection channels.

FIG. 10 shows a reverse assignment matrix for the traffic pattern of FIG. 9.

FIG. 11 shows a configuration matrix corresponding to the traffic pattern of FIG. 9 with protection channels added.

FIG. 12 is a reverse assignment matrix corresponding to FIG. 11 and corresponding to FIG. 10 augmented with protection channels.

FIG. 13 is a flow chart of a greedy scheduling algorithm.

FIGS. 14A-E present an example of background compaction.

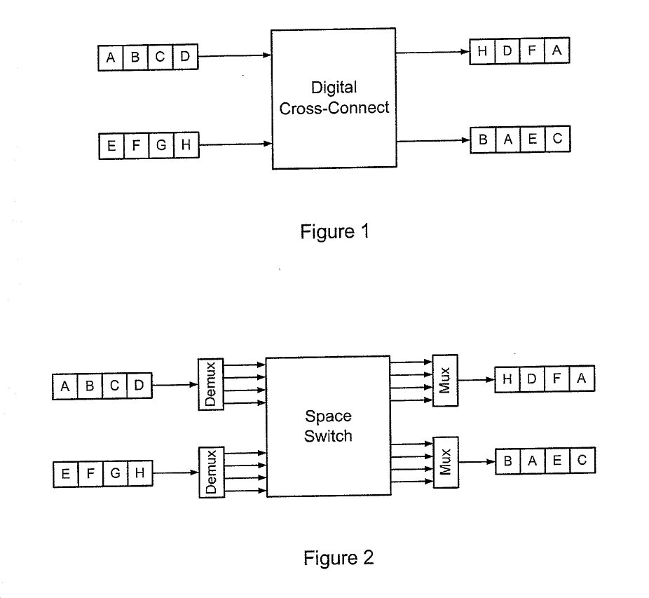

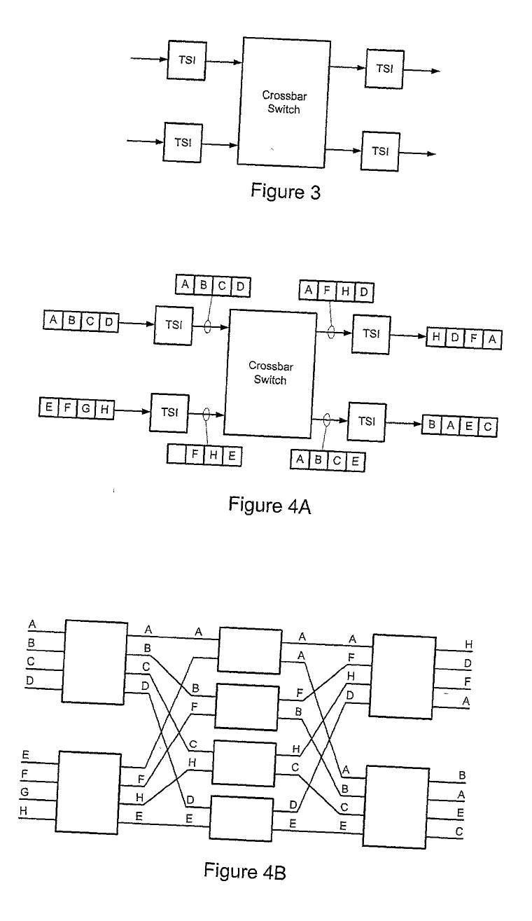

### DETAILED DESCRIPTION OF THE INVENTION

A description of preferred embodiments of the invention follows.

Consider a Clos network with r n x m-port input switches, m r×r port middle-stage switches, and r m ×n-port output switches. Such a network has p=r×n input ports and p output ports. In the example of FIG. 4B, r=2, n=4 and m=4. With speedup, there are more middle stage switches than input or output switches. For a speedup of s, m=s×n. As one example of an equivalent T-S-T network, the Velio VC2002 grooming switch has r=72 TSIs each at the input and output, n 48 and m=96 middle stage time slots. Thus, in the VC2002, input/output time slots and the input and output switches are realized in the time domain (as time-slot interchangers) and the middle switches are realized as a space switch multiplexed over the time slots. A maximally configured 3-stage folded Clos network built from VC2002 parts has r =72, n=1152, and m =2304. In this case, the 72 input switches each switch 1152 input time slots (48 time slots by 24 input ports) to 2304 output time slots (48 time slots by 48 output ports). Each middle stage switch switches 72 ports to 72 ports (there are logically 48 of these middle stage switches on each middle stage VC2002). The output switches are a mirror image of the input switches.

A configuration of the Clos network is a set of connections C={(x,Y)}. Each connection, also called a call, (x,Y) specifies an input switch, x, and a set of output switches, Y. For purposes of scheduling we do not distinguish between the ports on each first or last stage switch. Thus, we only distinguish r possibilities for values of x or elements of Y rather than r×n. It is useful to express a configuration as a matrix C where column j of C, denoted C_{*j} , corresponds to a switch (input or output) and row i of C, denoted C_{i*}, corresponds to a connection. An entry Cᵢⱼ in this matrix is a “1” if connection i involves input or output switch j. By convention, the first r columns of C correspond to input switches and the second r columns of C correspond to output switches.

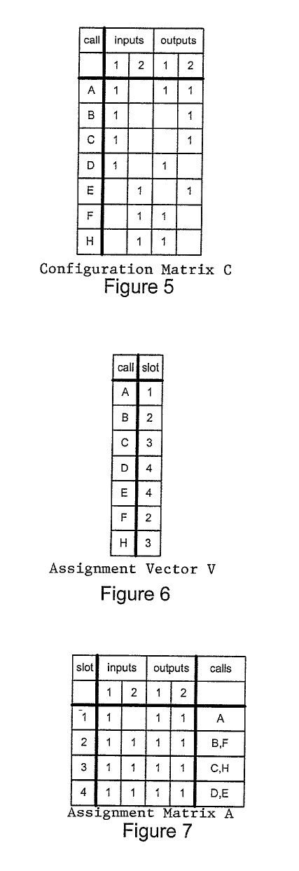

FIG. 5 shows a configuration matrix for the set of calls shown in FIGS. 4A and 4B. Here the configuration matrix has seven rows corresponding to calls (channels) A-F and H and four columns corresponding to input ports 1 and 2 and output ports 1 and 2. Since call G is not connected to any output it is not included in the configuration matrix. The first row shows that call A connects from input port 1 to output ports 1 and 2. The second row shows that call B connects from input port 1 to output port 2. The other rows show the input and output ports used by the remaining calls. Note that each column has at most four entries (in this case, exactly four entries), since there are four time slots on each input and output port.

The configuration matrix must follow the following restrictions:

1. The number of columns is 2r (the number of input plus output switches), 4 in FIG. 5 and 144 for the VC2002. By convention, the first r columns correspond to input switches, and the last r columns correspond to output switches.

2. The number of rows is no more than n×r. (8 for FIG. 5 and 3456 for the VC2002). For multicast configurations, the number of rows will be less than this number. For example, dual-cast call A uses two output slots with a single call, thus reducing the total number of rows to 7 for this example.

3. No column can have more than n is (4 for FIG. 5 and 48 for the VC2002). This is the maximum number of connections that can occupy a single input or output switch.

4. No row can have more than F+1 is where F is the maximum multicast fanout. Of these F+1 1s, one must be on the input ‘side’ of the row and the remaining F on the output side. When we deal with prescheduled protection switching, we will allow F+2 1 s per row where a second 1 on the input side is used to reserve the time slot for the protection input.

The scheduling problem is to assign each connection to a middle stage switch of FIG. 4B (time slot in FIG. 4A) so that all connections are assigned and there are no conflicts. We can consider this assignment as a vector V where Vᵢ=j if connection C_{i*} is assigned to middle-stage switch j (FIG. 4B) or time slot j (FIG. 4A). The assignment is free of conflicts if all connections that share a middle stage switch (time slot) are disjoint. That is, for all j, the intersection of all connections C_{i*} where vᵢ=j is empty; the rows in the configuration matrix, corresponding to connections which share a middle switch (time slot) j, share no input switches or output switches. The assignment vector for the configuration shown in FIGS. 4A, 4B and 5 is shown in FIG. 6. Call A is assigned to time slot 1, calls B and F to time slot 2, and so on.

The switch (time slot) assignment of FIG. 6 can be shown to present no input or output switch conflicts. For example, switch (time slot) 2 is shared by connectors B and F. Looking to the configuration matrix of FIG. 5, connection B uses input switch 1 and output switch 2, while connection F uses input switch 2 and output switch 1. There is no input/output switch conflict between those connections.

It is often useful to refer to an assignment matrix, A, where the i-th row of A, A_{i*} is the union of the connections assigned to middle stage i. That is, A_{i*} is the union of C_{j*} where vⱼ=i. Row i of A, A_{i*}, corresponds to middle-stage switch (time slot) i and has a bit set for every assigned port on this switch (time slot). Column j of A, A_{*j}, corresponds to input or output switch j, and has a bit set for every assigned port on this switch. The assignment matrix for our example of FIGS. 4 through 6 is shown in FIG. 7. Call A in time slot 1 uses input port 1 and both output ports. Calls B and F together use all of the ports in time slot 2. Similarly, C and H in time slot 3 and D and E in time slot 4 use all available ports.

The assignment matrix can be seen as the configuration matrix collapsed such that plural rows of the configuration matrix which do not require the same input or output ports are combined in a single row of the assignment matrix.

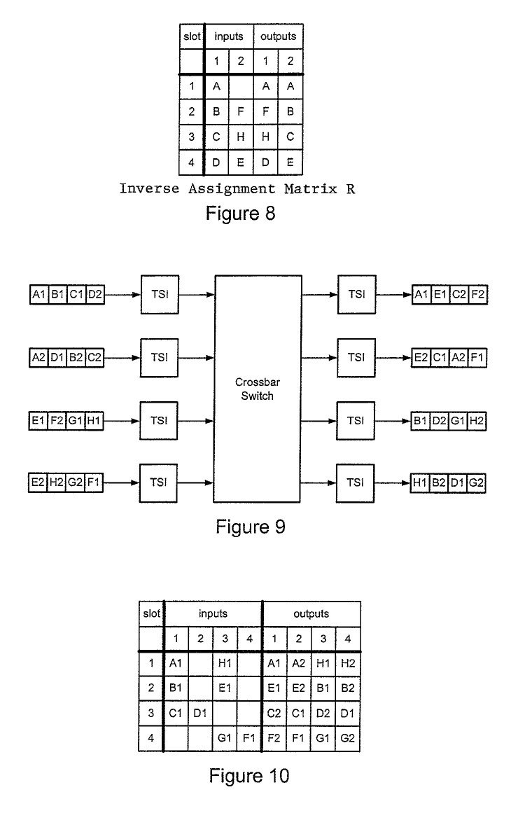

To aid in some scheduling procedures, we also record the inverse assignment in matrix R. Rᵢⱼ=k if the j-th port on middle-stage switch (time slot) i is assigned to connection k. The inverse assignment matrix for the example of FIGS. 4 through 7 is shown in FIG. 8. The entries are the same as for FIG. 7, but now each entry indicates the call that is using the corresponding port during the corresponding time slot.

By convention, port numbers cover the input side of the middle-stage switch first, then the output side. Also, for unicast calls, we denote the input switch of call i as Sᵢ and the output switch of call i as Dᵢ.

Basic Scheduling

When the number of middle stage switches, m, is at least 2n- 1, where n is the number of ports on each input and output switch, then the 3-stage network is strictly non-blocking for unicast traffic. To schedule a unicast call C_{i*}=(x, {y}) from input switch x to output switch y, on such a fabric we simply need to find a common idle middle stage switch (time slot) on switches x and y. This can be quickly calculated as:

Vᵢ=index_{—}first_{—}zero(A_{*x}∪A_{*y})

where index_first₁₃ zero(V) returns the index of the first zero element in vector V, and A_{*x} and A_{*y} are columns of the assignment matrix of FIG. 7. This can be found in time logarithmic in the number of middle stage switches if a tree circuit is used to find the first zero. In practice, if the columns of A are represented with bit vectors, the computation is very fast. We read the two column vectors, OR them together, and use a tree to find the first zero.

To schedule a unicast call C_{i*}=(x, {y}) on a switching fabric that is rearrangeably non-blocking, but not strictly non blocking (that is, where n<=m<=2n-1), one first attempts the procedure described above. If this fails because the intersection is null, then the following procedure is performed.

```
a = index_first_zero(A_{*x})
b = index_first_zero(A_{*y})
DO
  j = R_{ay}
  x = Sⱼ
  k = R_{bx}
  y = Dₖ
  Vⱼ = b //move j from a to b
  Vₖ = a // move k from b to a
UNTIL j or k is not assigned
Vᵢ = a // assign i to a
```

This procedure implements the looping algorithm of Benes (V.E. Benes, Mathematical Theory of Connecting Networks and Telephone Traffic, New York Academic Press (1965)). Note that the assignments to V must update the A and R matrices as well for this algorithm to work.

This procedure assigns the new call to the first open port on its input switch and then recursively moves the calls that interfere with this call. The procedure is guaranteed to terminate but in the worst case takes time proportional to the number of input and output switches, 2r—the chain of rearranged calls may touch every switch.

This procedure can only be used for unicast calls. However, if m>=2n, we can treat a fanout-of-two connection C_{i*}=(x, {y, z}) as two unicast connections: (x, {y}) and (x, {z}) and then apply this rearranging procedure.

Scheduling High Fanout Calls

When the fanout is greater than 2 (or p if m=sn) we can no longer guarantee the ability to schedule multicast calls using the procedure described above. To schedule these larger multicast calls, the key factor is dividing the fanout between the input stage and the middle stage. With a fanout off, the best scheduling is achieved when the fanout is equally divided between the two stages with sqrt(f) (square-root of f) fanout in the input stage, and sqrt(f) fanout in the middle stage. Thus, each fanout f connection is partitioned into g =ceiling(sqrt(f)) connections, each with a fanout of at most h=f/g. (The ceiling function gives the smallest integer greater than the argument; that is, it rounds up to the nearest integer.) For example, suppose f-4, the connection (x, {a,b,c,d}) is partitioned into (x, {a,b}) and (x, {c,d}).

Even after this partitioning, however, the scheduling problem that remains is difficult and an exact solution cannot be guaranteed. Heuristics, however, work well in practice.

One heuristic is a greedy algorithm that works by packing as many calls as possible into one row of the assignment matrix A and then moving on to the next row. While this algorithm is not guaranteed to find an optimal solution, with a reasonable speedup (for example, when m=2n) the greedy algorithm is able to pack all calls into middle stage time slots with high probability.

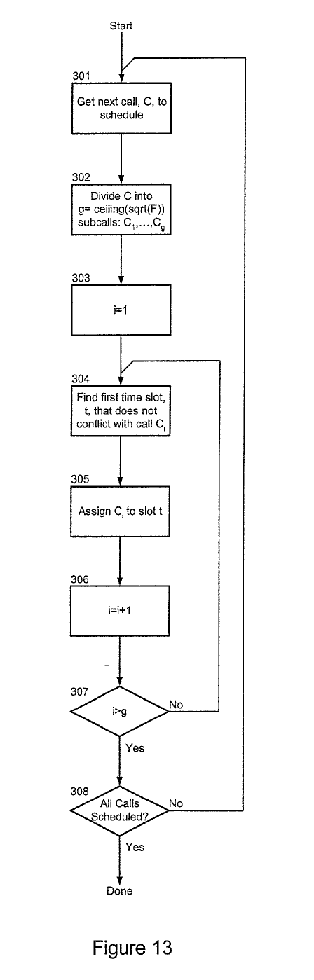

FIG. 13 shows a flowchart for this method of splitting calls to schedule calls with high fanout. The method operates iteratively as a doubly-nested loop. The outer loop splits and schedules each call in the call set in turn. The inner loop schedules each subcall of the current call.

The process begins in box 301 by getting the next call in the call set, call C, to be scheduled. The request for call C, with a fanout of F consists of an input port I, and a list of F output ports, O₁, O₂, . . . , O_{F}. In box 302 call C is split into g=ceiling(sqrt(F)) subcalls C₁,C₂, . . . , C_{g} each of which has a fanout of at most g. This splitting can be accomplished, for example, by assigning outputs O₁ to O_{g} to C₁, O_{g+1} to O_{2g}to C₂, and so on.

Boxes 304 to 307 form a loop that schedules each of the subcalls of call C in turn. Box 303 initializes the loop index, i, for this loop. Each subcall C, is scheduled by finding the first time slot, t, (row of the assignment matrix) that does not conflict with subcall Cᵢ in box 304. Subcall Cᵢ is then assigned to slot t and the assignment matrix updated to reflect this assignment in box 305. Box 306 updates the loop index for the next iteration, and decision 307 checks if all subcalls of C have been scheduled. If i<=g, subcalls remain to be scheduled and the process jumps to box 304 to handle the next subcall.

After exiting the inner loop, decision 308 checks if all calls have been scheduled. If calls remain to be scheduled, the process jumps back to box 301 to get the next call to be scheduled.

Calculating Blocking Probability

We can calculate the probability of blocking while setting up a random set of calls by maintaining a vector of occupancy probabilities for each time slot of each input and output port in the switch. Let Eᵢⱼ be the expected number of calls assigned to middle switch (time slot) j after the ith call is scheduled. Before any calls are scheduled, E_{0j =}0 for all j. We then calculate Eᵢⱼ from E₍ᵢ₋₁₎ⱼ and Eᵢ₍ⱼ₋ₗ₎ as:

Zᵢⱼ=((r−E₍ᵢ₋₁₎ⱼ)/r)^{F+1}

Xᵢ₀=Zᵢ₀

Xᵢⱼ=(1−Yᵢ₍ⱼ₋ₗ₎)Zᵢⱼ

Yᵢ₀=Xᵢ₀

Yᵢⱼ=Yᵢ₍ⱼ₋₁₎+Xᵢⱼ

Eᵢⱼ=E₍ᵢ₋₁₎ⱼ+Xᵢⱼ

We start by calculating Zᵢⱼ, the probability that a random call with a fanout of F can be scheduled into a slot that already has an expected occupancy of E₍ᵢ₋₁₎ⱼ. A call with a fanout of F has F+1 ones in its configuration vector and the probability of each of these ones having a conflict in a row with occupancy E₍ᵢ₋₁₎ⱼ is (r-E₍ᵢ₋₁₎ⱼ)/r. Thus the probability of all F+1 ones having no conflict is ((r-E₍ᵢ₋₁₎ⱼ)/r)^{F+1} giving us the first equation.

We then compute Xᵢⱼ, the probability that call i will be packed into slot j. This is the product of the probability that it will fit into slot j, Zᵢⱼ, and the probability that it hasn't already been packed into a previous slot, (1−Yᵢ₍ⱼ₋₁₎). This computation requires the calculation of Yᵢ₍ⱼ₊₁₎ the probability that call i has been scheduled on a slot between slot 1 and slot (j−1). This is calculated as a running sum of Xᵢₘ for m from 1 to the previous slot, (j−1). Note that there is no circular dependency between X and Y since the computation of Xᵢⱼ and Yᵢⱼ depends only on Xᵢ₍ⱼ₋₁₎and Yᵢ₍ⱼ₊₁₎.

Finally, the expected occupancy of slot i after call j, Eᵢⱼ is calculated as the running sum of Xₘⱼ for call m from 1 to the present call, i.

For example, if we performing this calculation for the parameters of the VC2002, r=72, m=96, n=48, and fanout F=2, we find that for the first call, E₁₁=1 and E₁ⱼ=0 for all j>1 because the greedy algorithm will always pack the first call into the first slot. For the second call the probability that it is packed into the first slot is X₂₁=(71/72)³=0.959 and if its not packed in the first slot, it always fits into the second slot X₂₂=0.041. This gives E₂₁=1.959 and E₂₂=0.041. For the third call, X₃₁=(72-1.959/72)³=0.921. This leads to E₃₁=2.79, E₃₂=0. 120, and E₃₃=0.0001. Continuing this calculation for all 1728 dual-cast calls, we find that the probability that the last stage is occupied at all E₍₁₇₂₈₎₍₉₆₎ is vanishingly small.

Scheduling Example

To see the advantage of splitting calls, consider the following pattern of nine calls (connections A, B, C, E, F, G, I, J, K), each with a fanout of three, where each input and output port has three time slots. The call set is expressed as a configuration matrix where each column is an input or output switch.

| | Inputs | Outputs |
|---|---|---|
| S1 A | 1.... | 111...... |
| S2 B | 1.... | ...111... |
| S3 C | 1.... | ......111 |
| S4 E | .1... | 1..1..1.. |
| S5 F | .1... | .1..1..1. |
| S6 G | .1... | ..1..1..1 |
| S7 I | ..1.. | 1...1...1 |
| S8 J | ..1.. | .1...11.. |
| S9 K | ..1.. | ..11...1. |

In assigning connections to middle switches (time slots), one would like to share switches (time slots) between connections to collapse the assignment matrix. However, this call set is mutually conflicting since any two calls require one or more of the same output switches. Since no two calls can be combined it takes nine middle stage time slots S1-S9, one for each cell, to schedule this call set. However, if we split the calls as follows:

| | Inputs | Outputs |
|---|---|---|
| A1 | 1.... | 11....... |
| A2 | 1.... | ..1...... |
| B1 | 1.... | ...11.... |
| B2 | 1.... | .....1... |
| C1 | 1.... | ......11. |
| C2 | 1.... | ........1 |
| E1 | .1... | 1..1..... |
| E2 | .1... | ......1.. |
| F1 | .1... | .1..1.... |
| F2 | .1... | .......1. |
| G1 | .1... | ..1..1... |
| G2 | .1... | ........1 |
| I1 | ..1.. | 1...1.... |
| I2 | ..1.. | ........1 |
| J1 | ..1.. | .1...1... |
| J2 | ..1.. | ......1.. |
| K1 | ..1.. | ..11..... |
| K2 | ..1.. | .......1. |

These calls can then be scheduled using the greedy algorithm into only six switches (time slots) with the following assignment matrix:

| | Inputs | Outputs | | | | |
|---|---|---|---|---|---|---|
| S1 | 111.. | 111...1.1 | A1 | A2 | E2 | I2 |
| S2 | 111.. | ...111.11 | B1 | B2 | G2 | K2 |
| S3 | 111.. | 11.1.1111 | C1 | C2 | E1 | J1 |
| S4 | .11.. | .1..1.11. | F1 | F2 | J2 | |
| S5 | .11.. | 1.1.11... | G1 | I1 | | |
| S6 | ..1.. | ..11..... | K1 | | | |

Alternatively, the partitioned call set can be mapped into six switches (time slots) as follows:

| | Inputs | Outputs | | | |
|---|---|---|---|---|---|
| S1 | 111.. | 11....1.1 | A1 | E2 | I2 |
| S2 | 111.. | 1111.1... | A2 | E1 | J1 |
| S3 | 111.. | ...11.1.1 | B1 | G2 | J2 |
| S4 | 111.. | .1..11.1. | B2 | F1 | K2 |
| S5 | 111.. | 1.1.1111. | C1 | G1 | I1 |
| S6 | 111.. | ..11...11 | C2 | F2 | K1 |

Thus, it is clear that partitioning calls into subcalls results in more efficient scheduling. Where calls conflict in less than all of the output switches, nonconflicting portions of calls can be collapsed together to share middle switches (time slots). Different portions of a call collapse with portions of different calls.

Pre-Scheduling For Automatic Protection Switching

In some applications, for example SONET transport using unidirectional path switched rings (UPSR) each input channel appears on two input time slots on separate input ports and each channel is transmitted on two output time slots on separate output ports. At any given point in time, one of the input time slots carrying the channel (the ‘working’ input channel) is selected and the switch connects this time slot to both output time slots associated with this channel. The other input time slot carrying the channel is not connected to any outputs. This time slot is referred to as the ‘protection’ input channel. In the event that the primary input channel is interrupted or degrades in quality, the switch is reconfigured to connect the ‘protection’ input channel to both outputs.

For example, FIG. 9 shows a four-port switch with four time slots per port and four internal time slots carrying eight channel pairs, one working and one protection channel per pair. For input channel A, for example, there is a working channel A1 on input 1 time slot 1 and a protection channel A2 on input 2 time slot 1. Working channel A1 is switched to both output A channels, channel A1 on output 1 time slot 1 and channel A2 on output 2 time slot 3.

FIG. 10 shows a reverse assignment matrix for the traffic pattern of FIG. 9. A time slot is assigned to each dual-cast from a working input channel to both output channels. Consider what happens when the signal on channel C1 degrades. In this case the switch must reconfigure to route input C2 to outputs C1 and C2. This requires a complete reschedule of the switch. There is no slot that has input slot 2 and output time slots 1 and 2 available. In a large switch this complete rescheduling is time consuming and greatly increases the amount of time required for protection switching.

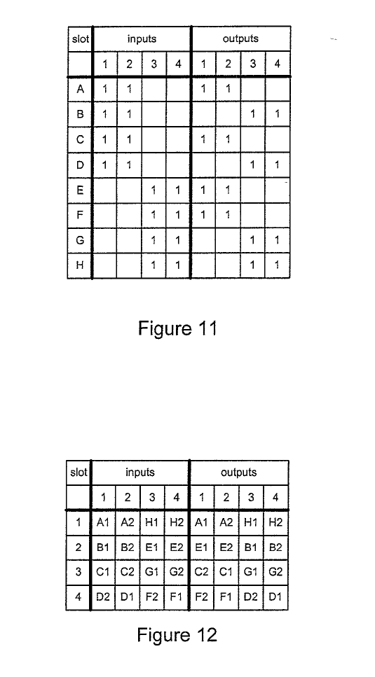

To overcome this problem, we schedule the protection input slot at the same time we schedule the working input slot. FIG. 11 shows a configuration matrix corresponding to the traffic pattern of FIG. 9 in which both the working and protection input ports are marked as ‘ones’ in each row. By marking both the working and protection input ports for each call, we pre-reserve the middle-stage time slot for the protection channel when we schedule the call and thus do not need to completely reconfigure the switch to switch one or more of the input channels between their working and protection sources.

FIG. 12 shows a reverse assignment matrix for the configuration matrix of FIG. 11. In this assignment each call has been assigned to a slot where both the working and protection input ports are free. During normal operation, the middle stage switch is configured to select the working input port during this time slot. To switch between the working and protection channels for a given call, the middle stage switch needs to change its configuration for two output ports during just a single time slot. The TSI configurations are unchanged and the middle stage configurations for other time slots and other output ports are also unchanged.

For example, consider the situation where input channel C1 degrades with the assignment of FIG. 12. To switch to the protection channel, C2, all that is needed is to switch the first two output ports from input port 1 to input port 2 during time slot 3. Thus this reconfiguration can be done extremely quickly.

Incremental Scheduling and Background Compaction

In typical applications new calls are set up one at a time or in small batches, a typical requirement is to handle 20 calls per second. Also in typical applications employing the greedy packing algorithm described above, a large number of middle stage switches (time slots) are usually left idle.

These two properties can be exploited to set up new calls extremely rapidly but with an inefficient schedule, and then to compact the schedule as a background task. With this approach, at any given point in time the set of m middle stage switches is partitioned into two subsets: set B of size m_{B} holds all previously scheduled calls and set F of size m_{F} holds all middle stage switches used by the current set of calls and all free switches. Set B is owned by the background compaction process and set F is owned by the new call setup process.

When a new call or set of calls arrives to be scheduled, the new call setup process is activated. It assigns these calls to a set, G, of middle stage switches from set F, removes G from F, and passes the calls, and set G to the background process. Because the new call setup process deals with a small problem size (a small number of calls (often 1) and a small number of middle stage switches) it can run very fast, resulting in low setup latency. Also, because the schedule will later be compacted, it need not be very efficient. This can lead to further speed advantages as the new call setup process need not search for an optimum schedule, but can settle for one that works. For example, the process could simply assign each new call to a separate middle-stage switch (assuming that enough switches were available).

The background compaction process runs continuously whenever no foreground process, like the new call setup process, is running. Compaction takes place in a series of passes. On each pass, the compaction process does the following:

initially set C contains all calls previously scheduled onto middle stage timeslots B

all calls in sets G received from the setup process are added to C, the set of calls to schedule

any calls disconnected since the last pass are removed from C

all middle stage switches in any sets G are added to set B

calls in C are scheduled onto switches B

if the schedule is compacted, any free switches are removed from set B and added to set F

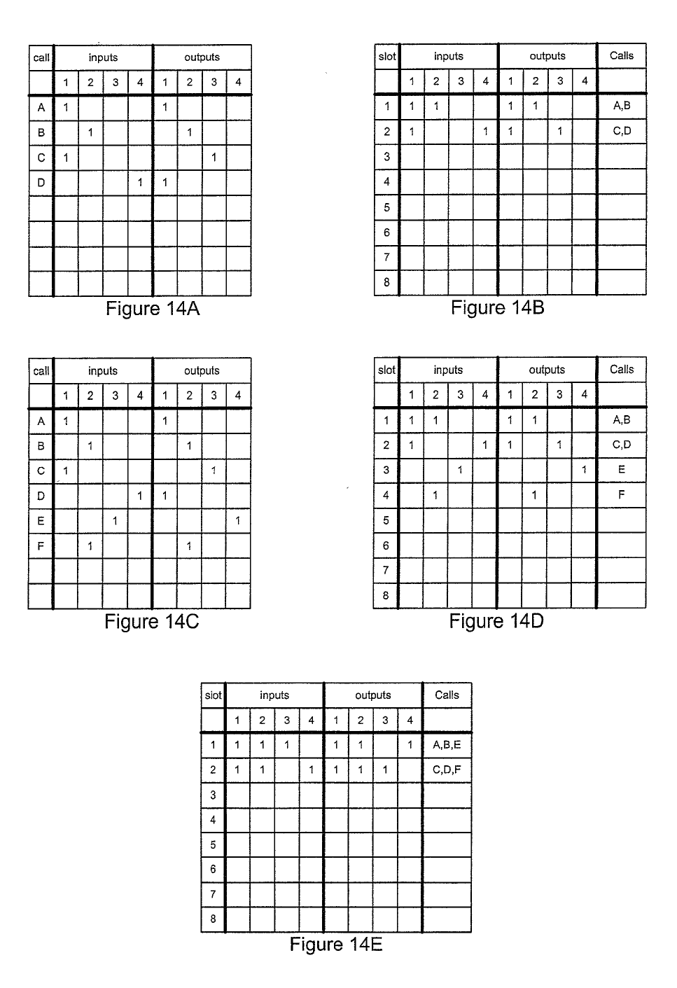

An example of background compaction is shown in FIGS. 14A through 14E. FIG. 14A shows an initial set of four unicast calls A-D that need to be set up on a switch. These four calls are compacted into two slots, slots 1 and 2, using the greedy algorithm as shown in FIG. 14B. Slots 1 and 2 then form the background set of slots B, and the remaining slots 3 through 8 are in set F, free for allocation by the foreground process. Some time later, two new calls, E and F, are presented for scheduling on the switch as shown in FIG. 14C. These calls are quickly set up by assigning each to its own free slot as shown in FIG. 14D. Call E is assigned slot 3 and call F is assigned slot 4. After calls E and F are set up, slots 3 and 4 become set G and are passed to the background compaction process, leaving slots 5 through 8 in set F. The background compaction process then recompacts the calls as shown in FIG. 14E. After this compaction, slots 3 and 4 are returned to set F to be used to rapidly set up new calls as they arrive.

Partitioned Scheduling

Partitioning the set of calls and the set of middle-stage switches can also be used to accommodate different types of traffic. For example, to handle unicast and multicast calls with different algorithms, the calls are partitioned into a set of unicast calls C₁ and a set of multicast calls Cm; and the switches are partitioned into a set of unicast switches (slots) B₁, and a set of multicast switches (slots), Bₘ. The unicast calls can be scheduled using the looping algorithm, and the multicast calls can be scheduled using the greedy algorithm. Since unicast and multicast calls rely on different sets of middle switches (slots) each can be scheduled without conflict without regard for the other. This technique can be combined with the background compaction method by further partitioning the multicast calls and switches into foreground and background sets.

Even where the same algorithm is used for all calls, partitioning can reduce the scheduling time for each call since scheduling is within a smaller set of calls.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of scheduling a multicast call with other calls on a network of at least three stages comprising:
dividing the calls into a plurality of call portions;
scheduling the call portions with the other calls..

2. A method as claimed in claim 1 wherein the network is a time-space-time-network.

3. A method as claimed in claim 1 wherein the network is a space-space-space network.

4. A method as claimed in claim 1 wherein a fanout of F call is divided into two F/2 calls.

5. A method as claimed in claim 1 wherein a fanout of F call is divided into about a square root of F calls.

6. A method as claimed in claim 1 wherein a fanout of two call is divided into two unicast calls.

7. A method as claimed in claims 6 wherein a unicast call is scheduled using a looping algorithm.

8. A method as claimed in claim 1 wherein a unicast call is scheduled using a looping algorithm.

9. A method of scheduling a call with a protection channel comprising:
augmenting a call by adding an input switch containing a protection channel to the call; and
scheduling the augmented call.

10. A method as claimed in claim 9 wherein calls are scheduled from a configuration matrix with two non-zero entries on the input side.

11. A method as claimed in claim 10 wherein calls are scheduled using a greedy algorithm.

12. A method of scheduling calls comprising:
maintaining a first set of calls on a first set of middle stage switches or time slots;
scheduling new calls on a second set of middle stage switches or time slots drawn from a set of free middle-stage switches or time slots;
adding the scheduled new calls to the first set of calls and the second set of middle stage switches or time slots to the first set of middle-stage switches or time slots; and
on occasion, recompacting the first set of calls on the first set of middle stage switches or time slots.

13. A method as claimed in claim 12 wherein new calls are assigned one per middle stage switch.

14. A method as claimed in claim 12 wherein new calls are scheduled using a greedy algorithm.

15. A method as claimed in claim 12 wherein middle-stage switches or slots freed by recompacting are returned to the set of free middle-stage switches or time slots.

16. A method of scheduling calls comprising:
assigning a first set of calls to a first set of middle-stage switches or time slots and a second set of calls to a second set of middle-stage switches or time slots; and
separately scheduling the first and second sets of calls.

17. A method as claimed in claim 16 wherein the first set of calls is scheduled with a first algorithm and the second set of calls is scheduled with a second algorithm.

18. A method as claimed in claim 17 wherein the first set of calls are unicast calls and the first algorithm is a looping algorithm.

19. A method as claimed in claim 17 wherein the second set of calls are multicast calls and the second algorithm is a greedy algorithm.
